(19) United States
(12) Patent Application Publication
(10) Pub. No.: US 2009/0304244 A1
(43) Pub. Date: Dec. 10, 2009

(54) Method and a system for presenting sections of a histological specimen

(75) Inventors: Tsafrir Kolatt, Haifa (IL); Eldad Klaiman, Haifa (IL)

Correspondence Address: MARTIN D. MOYNIHAN d/b/a PRTSI, INC., P.O. BOX 16446, ARLINGTON, VA, 22215, US

(73) Assignee: Applied Spectral Imaging Ltd., Migdal HaEmek (IL)

(21) Appl. No.: 12/385,532

(22) Filed: Apr. 10, 2009

Related U.S. Application Data
(60) Provisional application No. 61/129,151, filed on Jun. 6, 2008.

(51) Int. Cl. G06K 9/00; G01N 1/30

(52) U.S. Cl. 382/128; 435/40.52

(57) ABSTRACT

A method for presenting at least one structure of a histological specimen. The method comprises providing a plurality of images of a plurality of sections of a single histological specimen having a plurality of structures, segmenting a plurality of segments of the plurality of structures in each the image, associating among respective the segments of a common structure of the plurality of structures, and presenting the association in relation to at least some of the plurality of images.

### RELATED APPLICATION

This application claims the benefit of U.S. Provisional Patent Application No. 61/129,151, filed on Jun. 6, 2008, the contents of which are incorporated herein by reference.

### FIELD AND BACKGROUND OF THE INVENTION

The present invention, in some embodiments thereof, relates to a system and a method for supporting histological analysis and, more particularly, but not exclusively, to a system and a method for supporting the histological analysis of specimens obtained from a common biological source.

In the field of medical diagnostics, the detection, identification, quantization and characterization of regions of interest, such as tumor regions, through testing of biological specimens is an important aspect of diagnosis. Typically, a biological specimen such as bone marrow, lymph nodes, peripheral blood, cerebrospinal fluid, urine, effusions, fine needle aspirates, peripheral blood scrapings or other materials are prepared by staining the specimen to identify regions of interest. One method of histological specimen preparation is to react a specimen with a specific probe which may be a monoclonal antibody, a polyclonal antiserum, or a nucleic acid which is reactive with a component of the region of interest, such as tumor cells. The reaction may be detected using an enzymatic reaction, such as alkaline phosphatase or glucose oxidase or peroxidase to convert a soluble colorless substrate to a colored insoluble precipitate, or by directly conjugating a dye to the probe.

Typically, biological specimens are prepared by fixing the biological material onto microscopic slides and staining them using a variety of staining methods, such as morphological and cytogenetical stains. Stained specimens are then evaluated for the presence or absence of cancerous or abnormal regions or cells. Cytogenetical staining may be useful for the identification of specific chromosomal aberrations. Examples of cytogenetical staining include but are not limited to fluorescent in situ hybridization (FISH), radiolabeled in situ hybridization, Digoxygenin labeled in situ hybridization and biotinylated in situ hybridization.

Various bio-imaging approaches are routinely utilized for both research and diagnostic purposes. Several bio-imaging methods are currently used in clinical and research practice, inter alia, for the diagnosis of hematological malignancies including cancers. In histology and immunohistochemistry the common practice is to bind fluorescent dyes, such as chromophores, or absorbent dyes, such as chromogens, that may be observed by excited emission, transmission or reflection, (see David L. Spector and R. D. Goldman (2005). Basic Methods in Microscopy. New York Cold Spring Harbor Laboratory Press) that is incorporated herein by reference. Such staining methods or protocols are vital in order to reveal the content and structure of cells in sections of a histological specimen. In some cases, more than one staining method should be performed in order to reveal enough details about the histological specimen. In these cases different sections of the same histological specimen may have to be processed according to different staining procedures and/or methods, which may be referred to herein as staining procedures. Different sections are needed as dyeing the same section of a histological specimen according to more than one staining method and/or protocol may not be possible as one staining method and/or protocol may counter the other. Furthermore, at times a certain staining procedure may only be determined and applied after the first analysis is performed on a differently stained section. In these cases a primary diagnosis is based on the staining of a section of the histological specimen according to a first staining procedure. If this diagnosis reveals that the histological specimen should be further analyzed, one or more additional sections of the histological specimen are stained according to another staining procedure, usually a more targeted one.

In general, staining procedures may be used for general and specific applications. Common staining dye for general application is Hematoxylin and Eosin (H&E) dye that is often used to reflect the acidity-basophilic nature of a specimen. Similarly, a Giemsa dye, wherein Methylene blue replaces the Hematoxylin, is also broadly used to differentiate chromosomes, cytology specimens and various bacteria. Since every chemical entity bears, for instance, an acidity value this sort of staining does not target specific compounds. Such a staining may be used for differentiating the sought-after structures from the background and/or from other elements.

Common staining dyes for specific applications are FISH and CISH and Diamino Benzidine tetrahydrochlorid (DAB), 3-Amino-9-ethylcarbazole (AEC), and Fast-Red. A certain dye may be used for marking different proteins through binding and its meaning depends on the specimen context. Another specific application may assist in identification of specific bacteria, for example using Methylene blue and fuchsine (Ziehl-Nielsen) that is used for staining for bacilli.

Common staining protocols usually include a primary diagnosis that is based on a general staining of a section of a histological specimen and a secondary diagnosis that is based on a specific staining of another section of the histological specimen. For instance, core biopsies of prostate are first analyzed based on the H&E stained sections. If there is doubt with respect to the integrity of the prostate glands, a serial section is stained for the identification of, for example Cytokeratin 903, to verify or refute the initial suspicion, for example see Varma, M., M. D. Linden, et al. (1999). “Effect of formalin fixation and epitope retrieval techniques on antibody 34betaE12 immunostaining of prostatic tissues.” Modern Pathology 12(5): 472-8, which incorporate herein by reference.

It should be noted that the fixation of cells by cell dropping may be optimal for FISH analysis but worthless for morphological analysis since the cell cytoplasm is completely destroyed by the pre-treatment. In another case, cell smears are compatible with cell morphology but are not optimal for FISH analysis due to overlapping cells in the slide and the relatively low number of nucleated cells. In addition, multiple staining might result in inadequate results due to interference between the two staining methods. For example, the material used for the first staining method might leave some remnants on the cells, which appear as background to the second staining method. On another case the chromogenic substrates used by one staining method might obscure the chromogens used by the second staining method.

The stained specimens may be examined manually either by a lab technician or by a pathologist or automatically by automated cell analysis systems. When the stained specimen is probed by an automated cell analysis system a high power microscope is used for scanning a rack of slides, portions of which have been previously selected by an operator. The operator scans each slide and notes the points of interest on the slide for later analysis. Once the points of interest have been located and stored by the operator, the automated analysis system performs an image analysis.

For example, U.S. Pat. No. 7,177,454, filed on Feb. 3, 2003, describes a method, system, and apparatus are provided for automated light microscopic for detection of proteins associated with cell proliferative disorders and U.S. Pat. No. 7,272,252, filed on Sep. 18, 2007, that describes a method and apparatus for automated analysis of transmitted and fluorescently labeled biological samples, wherein the apparatus automatically scans at a low magnification to acquire images which are analyzed to determine candidate cell structures of interest. Once candidate structures of interest are identified, further analysis is conducted automatically to process and collect data from samples having different staining agents.

### SUMMARY OF THE INVENTION

According to an aspect of some embodiments of the present invention there is provided a method for presenting at least one structure of a histological specimen. The method comprises providing a plurality of images of a plurality of sections of a single histological specimen having a plurality of structures, segmenting a plurality of segments of the plurality of structures in each the image, associating among respective the segments of a common structure of the plurality of structures, and presenting the association in relation to at least some of the plurality of images.

Optionally, the method further comprises matching pixels of a segment of the plurality of segments with respective pixels of an associated segment of the plurality of segments.

Optionally, each the section is stained using at least one of a different staining procedure and a different staining agent.

Optionally, at least some of the associated segments are depicted in non-consecutive sections of the plurality of sections.

Optionally, the displaying further comprises aligning at least one of the plurality of images according to the association.

Optionally, the displaying further comprises reorienting at least one of the plurality of images according to the association.

Optionally, the associating comprises identifying a transformation between at least two of the plurality of segments.

Optionally, the associating comprises acquiring positional information of at least two of the associated segments, the presenting comprises adjusting the at least two of the associated segments according to the positional information.

Optionally, the method further comprises verifying the associating by matching positional information of at least two of the associated segments.

Optionally, each the section is positioned on a single specimen slide.

Optionally, the associating comprises coloring the associated segments in a single color.

Optionally, the associating comprises labeling the associated segments with a single label.

Optionally, the associating comprises scoring the similarity between at least one pair of the plurality of segments and associating the segments according to the scoring.

More optionally, the associating comprises generating a probability matrix according to the scoring and associating the plurality of segments according to the probability matrix.

According to an aspect of some embodiments of the present invention there is provided a system for presenting a histological specimen. The system comprises a receiving module for receiving a plurality of images of a plurality of sections of a single histological specimen having a plurality of structures and a matching module for mapping segments of each the structure in each the section and associating among respective the segments of a common structure of the plurality of structures. The system further comprises an output module for allowing the presenting of an indication of the association in relation to at least one of the plurality of images.

Optionally, the system further comprises a user interface for allowing a user to select at least one of the pluralities of segments, the matching module being for performing the mapping according to the selection, the associating comprises associating an area respective to the selected area.

Optionally, the matching module is for aligning the plurality of images according to the associating, the indication comprises the aligned images, the presentation unit being for displaying the aligned images to a user.

According to an aspect of some embodiments of the present invention there is provided an apparatus for allowing the presentation of a single histological specimen. The apparatus comprises a receiving module for receiving a plurality of images each of a different section of a single histological specimen, a user interface for allowing a user to select a first area in a first location in one of the plurality of images, and a matching module for identifying a second area in a second location in another of the plurality of images. The second location being respective to the first location. The apparatus further comprises an output module for allowing the presenting of an association between the first and second areas according to the identification.

Optionally, the matching module is for identifying the second area by segmenting a plurality of segments of a plurality of structures of the single histological specimen in each the image, and associating among segments of each the structure.

Optionally, the receiving module is configured to receive the plurality of images from a microscope camera.

Optionally, the output module is for allowing the presenting automatically in response to the user selection of the first area.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for mapping structures of a histological specimen, according to some embodiments of the present invention;

FIG. 2 is a flowchart of a method for mapping structures of a histological specimen wherein the mapping is based on segment association and pixel matching, according to some embodiments of the present invention;

FIGS. 3 and 4 are images of exemplary slides with sections of a common histological specimen, which have been stained according to different staining procedures;

FIG. 5 is an image of an exemplary slide with two sections of a common histological specimen;

FIG. 6 includes exemplary images of non-consecutive sections of a common histological specimen, according to some embodiments of the present invention;

FIGS. 7a-i are schematic illustrations of common characteristics of an image of a section which may be taken into account during the matching process, according to some embodiments of the present invention;

FIGS. 8a-8f includes exemplary images of non-consecutive sections of a common histological specimen, according to some embodiments of the present invention;

FIG. 9 that is a schematic illustration of a system for mapping structures in sections of a histological specimen, according to some embodiments of the present invention; and

FIGS. 10 and 11 are respectively an image of exemplary graphical user interfaces (GUI) a window thereof that is used for displaying an association between two sections, according to some embodiments of the present invention.

### DESCRIPTION OF SPECIFIC EMBODIMENTS OF THE INVENTION

The present invention, in some embodiments thereof, relates to a system and a method for facilitating the analysis of biological specimens and, more particularly, but not exclusively, to a system and a method for presenting biological specimens obtained from a common biological source.

According to some embodiments of the present invention there is provided a system and a method for identifying, associating, and optionally mapping structures of a common histological specimen in different sections and presenting the association in a manner that facilitates the analysis of the common histological specimen by a user and/or an automated system. Each one of the sections may be stained by the same staining agent and/or protocol or by a different staining agent and/or protocol. Optionally, one section of the common histological specimen is reoriented and/or aligned according to the orientation of another section. Such a reorientation or alignment allows a lab technician or a pathologist to compare between segments of a certain structure of the common histological specimen in different sections. Optionally, segments of a certain structure are colored and/or labeled in the same manner in each one of the sections. Such a coloring and/or labeling assists the lab technician or the pathologist to identify different segments of the same structure in a number of different sections. Optionally, the system and/or the method maps equivalent areas on similar sections, either automatically or according to user inputs and/or definitions. Optionally, the pixels of a segment in a certain section are mapped to respective pixels of one or more associated segments in of other sections. Optionally, a non-unique mapping is used for associating a certain area in a certain section to several respective areas in one or more other sections and vice versa. As further described below, the association of the segments of a common structure may be performed with regard to unique characteristics of stained sections.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

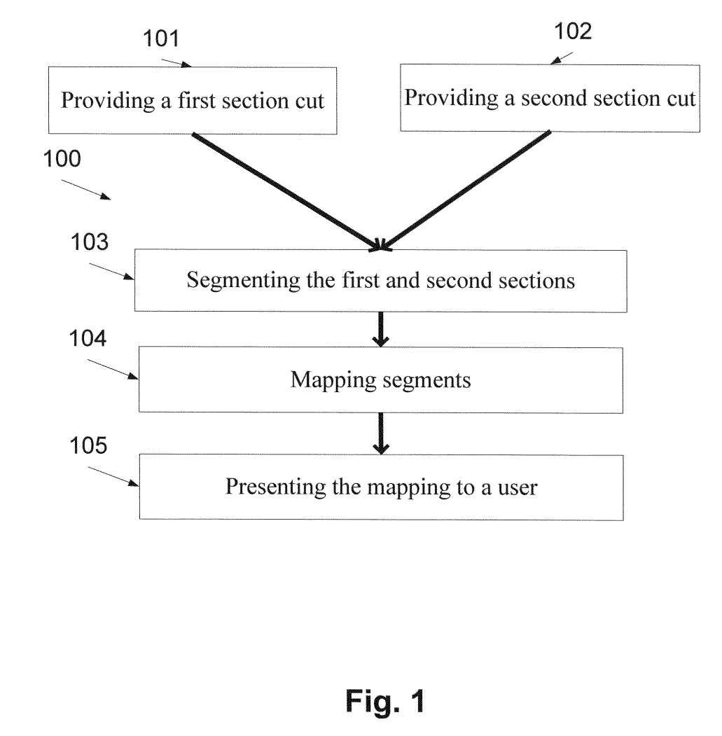

Reference is now made to FIG. 1, which is a flowchart 100 of a method for mapping structures of a histological specimen, according to some embodiments of the present invention. The method, which is depicted in the flowchart 100, allows a user, such as a pathologist, an immunopathologist, and clinical scientist, to associate structures of a histological specimen which are placed on different slides and/or on a common slide.

As commonly known and outlined in the background, various staining methods and protocols are used for analyzing histological specimens. Such staining methods and protocols may require the performing of a number of staining procedures, such as specific and general staining procedures, on a number of different sections of the histological specimen. The different sections may be provided on a common slide and/or on different slides. For example, as depicted in 101 and 102, first and second sections of a common histological specimen are provided.

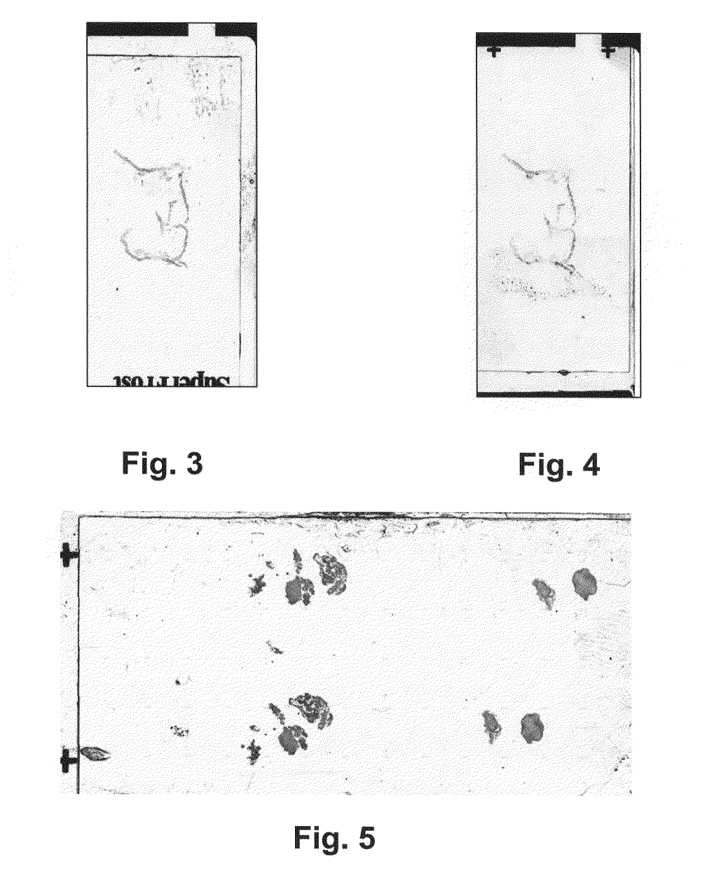

The first and second sections may be trimmed from a common histological specimen, such as a biological tissue. The histological specimen is optionally fixated in a block, such as a paraffin block and frozen array block that contains the histological specimen, such as a tissue or cytology related specimen. Usually, the histological specimen includes one or more structures. Each section includes cross sectional segments of the one or more structures, which may be referred to herein as segments. An example for such sections are provided in FIGS. 3 and 4, each depicting a slide that carries a different section of a common tissue array that includes prostate cores. The slide depicted in FIG. 3 is an outcome of an H&E staining procedure and slide depicted in FIG. 4 is an outcome of high molecular weight Cytokeratin 34BE12 (CK903) staining procedure. Optionally, images of the first and second sections are received from an imaging device, such as a microscope camera. Each image depicts segments of the different structures of a common histological specimen. Each segment may be independently distinct from the background, which is optionally a slice of uncolored paraffin block.

It should be noted that although the description mostly refers to only one pair of sections, any number of sections which have been trimmed from the common histological specimen may be provided and associated, optionally as further described below.

Then, as depicted in 103, the segments in each one of the sections are segmented, optionally as further described below. In some embodiments of the present invention, the segmenting includes identifying segments of different structures of the common histological specimen. These structures may include necrotic parts, granulomas, bone tissues, fat regions, and the like.

The segments of each structure may have a general outline and/or micro fingerprints, such as purple nuclei and pink cytoplasm that appears in an H&E staining procedure. The general outline of a certain structure, which may be referred to herein as a macro view, appears darker than the surrounding, which optionally appear as a “white light” background and may be fixated in the sections. The hues of elements which are part of the surrounding, such as cell debris, are optionally lighter than the hue of the structures that appear in the sections.

The method by which structures are found may depend on the used type of slides and may be performed according to a known segmentation method. Such segmentation methods are well known and will not, therefore, be described herein detail.

Optionally, the segmentation includes joining structure sections with relatively small area to form a single structure. Optionally, structure sections with an area below a certain threshold are joined with other structure sections with an area below the certain threshold which are positioned in a proximity thereto.

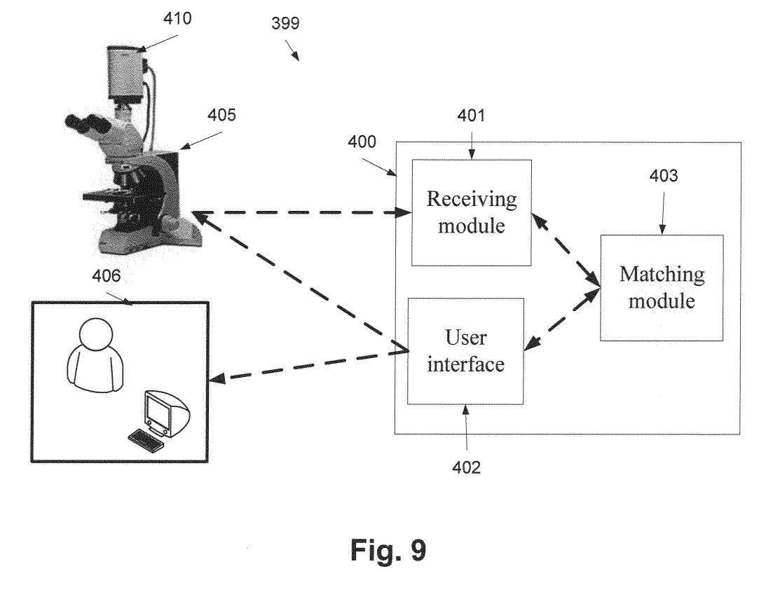

Now, after the sections have been segmented, as shown at 103, segments of the same structures at different sections are mapped, as shown at 104. Optionally, the segmenting and/or the mapping is performed on digital images of the sections which are captured using an image sensor, as further described below in relation to FIG. 9.

Such segmenting and mapping allow the examination and analysis of structures of the common histological from which the aforementioned sections have been trimmed. For example, when a pathologist diagnoses serial sections, she compares between cross sectional segments of a structure of the histological specimen, which may be referred to herein as segments. The segments may be located on an image of a different slide that has been stained differently. For example, the comparison between the sections which are depicted in FIG. 3 and FIG. 4 allows the pathologist to identify in the CK903 stained slide suspicious locations found on the H&E stained slide and extract the necessary information from this same tissue location, see U.S. Pat. No. 5,655,029 issued on Aug. 5, 1997, which is incorporated herein by reference. For clarity, the sections may be stained according to any staining procedure.

As used herein, mapping means arranging, tagging, labeling, coloring, and/or otherwise presenting segments of a certain structure of the histological specimen in a manner that allows a user, such as a lab technician or a pathologist, or a an automated cell analysis systems to identify the relation of the segments to the certain structure. Mapping may include aligning a slide and/or an image of one section in relation to a slide and/or an image of another section in a manner that position segments of the same structure in respective positions. As commonly known in the art, the examination and analysis may be performed either manually, by a lab technician or a pathologist, or automatically, by an automated cell analysis systems.

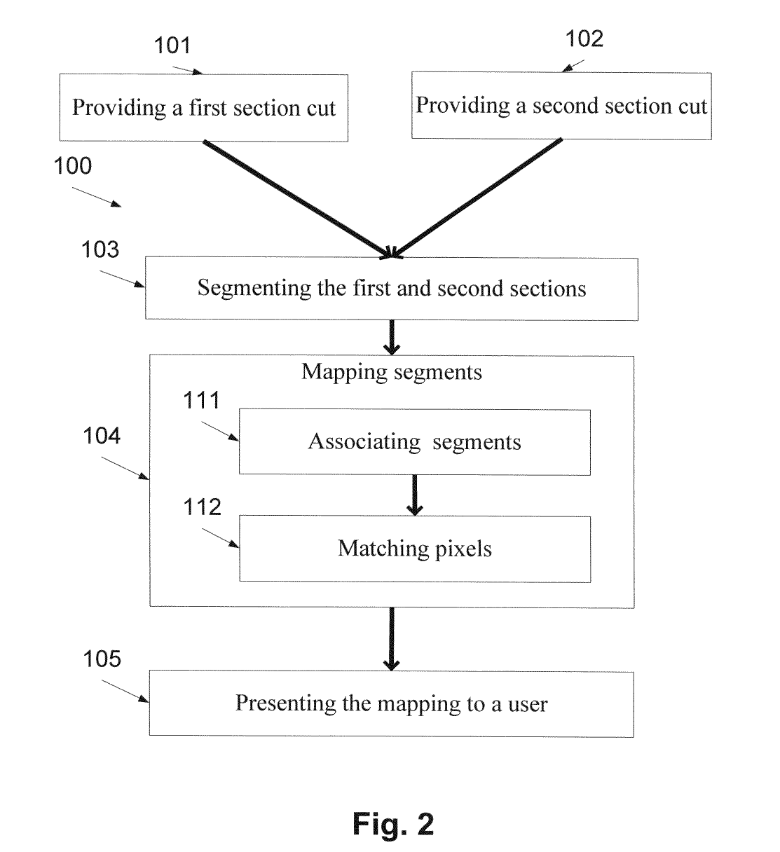

In some embodiments of the present invention the mapping is based one two steps, for example as depicted in FIG. 2. First, as shown at 111, segments of the same structure which are taken from different sections are associated. Then, as shown at 112, pixels of a certain segment are matched with respective pixels of one or more of the associated segments.

Optionally, pixels of a first section are mapped to respective pixels in a second section. The mapping process may be performed on any number of serial sections that reside on the same slide, as shown at FIG. 5 or on different slides, as shown at FIG. 3 and FIG. 4.

As shown at 105, after the segments have been mapped, as shown at 104, the mapping is presented to the user, optionally as further described below.

Reference is now made to a description of an exemplary mapping process. For the clarity of the following description, C denotes an image of a first section, R denotes an image of a second section, M denotes the number of segments to which C has been identified and N denotes the number of segments to which R has been identified. For brevity, M and N refer to arbitrary sets of segments that consist of the elements, optionally smallest, which are identified during the mapping process by any a known segmentation algorithm.

Optionally, each segment of the N segments of the image of the second section R, which may be individually referred to herein as Rₛⁱ where i=1, . . , N, may be associated with one or more of the following:
a. A respective segment of the M segments of the first section C, which may be individually referred to herein as Cₛ^{j} where j=1, . . . , M.
b. A cluster of L segments on the C, which may be referred to individually as Cₛ^{j}, Cₛ^{j+1}, . . . , and Cₛ^{j+L}. Each segment of the cluster may be separately associated with the segment.
c. None of the identified segments, Cₛ^{j}(j=1, . . . , M), on the “current” slide.

Optionally, each segment may be divided to a plurality of sub-segments. Each sub-segment may be associated according to any of the aforementioned options (a-c).

In some embodiments of the present invention, each distinct segment Rₛⁱ is associated with every distinct segment Cₛ^{j} of C. A similarity score is then assigned to each pair of segments (Rₛⁱ, Cₛ^{j}) to assess the probability of their resemblance. Such scoring allows the generation of a probability matrix that maps the estimated similarities between the segments. The values in the matrix may be normalized and/or assigned in a manner that defines the relation between them.

Optionally, if during the mapping process the similarity of two segments has been scored above a predefined threshold, the orientation of all the other structures is estimated accordingly. In such an embodiment, the orientation of some segments may be determined according to the orientation of associated structures. Optionally, a transformation that allows such an orientation is determined according to a transformation function which is based on the associated segments. In such a manner, there is no need to score the similarity with all the structures. Optionally, in order to reduce the computational complexity of the mapping process, a impressionsegment in a certain area may be matched only with segments which have been identified in a respective area.

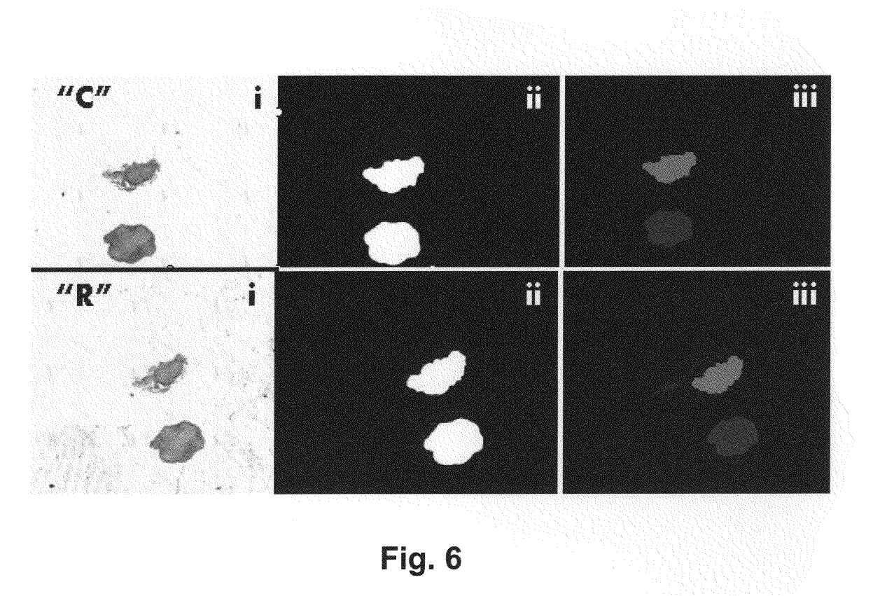

As described above, different sections may be stained according to different staining procedures and/or agents. Different staining procedures may dye the segments and/or the background in different colors or hues. In order to assure that segments of a certain structure in different sections are associated and mapped, these differences may be reset or considered. As further described below the images of the sections may be binarized before the mapping process. For example, as shown at FIG. 6, the segments C and R which are shown at the images which are tagged with I are binarized, as shown at step ii, and only then mapped. In FIG. 6 the mapping is presented to the user by coloring, as shown at iii. The binarization is optionally based on a binarization threshold value. Optionally, for each image, the threshold binarization value is dynamically determined according to a histogram of brightness that is independently constructed from cumulative values of the respective picture elements. In such a manner, the binarization threshold value is dynamically determined according to hue of the stainning process. Optionally, the binarization threshold value is determined according to color and/or hue differences between the background and the foreground of the section. In such an embodiment, the binarization threshold value may be determined according to a mean and/or an average of a histogram that is based on the background and a histogram that is based on foreground. Optionally, the brightness of the background is determined by the microscope light source and the foreground is defined according to the effect of the staining process on the segments and/or the cell detritus.

It should be noted that differentiating between the background and the foreground allows associating between foregrounds which have been stained differently.

Reference is now made to FIGS. 7a-7i, which are schematic illustrations of examples to possible distortions which may be brought about by characteristics of the sections. As described above, each one of the sections is a sequential section of a common histological specimen.

Optionally, the matching process, which is used for scoring the similarity between structures from different sections, takes into account one or more of the following characteristics, each exemplified in a respective figure of FIGS. 7a-7i:
a. Structure orientation—the structure orientation is determined according to a match between the locations of the matched segments on the slide. The structures orientation on the slide may be affected from the positioning of the carrying slide in front of the image sensor that has been used from capturing the image that depicts the matched segments. Moreover, the positioning of the section on the slide may be done by a human technician. Such a positioning does not ensure that the orientation of the section on the slides is similar and therefore the orientation of segments a common structure may not match. Optionally, the orientation is calculated by estimating local motion between the structures. The local motion may be an outcome of the placing of the slides that carry the sections or an outcome of the angle in which the related structure was trimmed. Optionally, the local motion is represented by a vector.

Optionally, the local motion is detected in a local motion identification process, such as an optic-flow algorithm, for example the optic-flow algorithm that has been published by A. Bruhn et al., see A. Bruhn et al. Real-Time Optic-flow Computation with Variational Methods. In N. Petkov, M A.

Westenberg (Eds.). Computer Analysis of Images and Patterns. Lecture Notes in Computer Science, Vol. 2756, Springer, Berlin, 222-229, 2003 and A. Bruhn et al., “Combining the advantages of Local and Global Optic-flow Methods, L.

Van Gool (Ed.), Pattern Recognition, Lecture Notes in Computer Science, Vol. 2449, Springer, Berlin, which are incorporated in their entirety by reference into the specification.
b. Section parity—The placement of a section on the slide is usually done manually after the section has been stained in a preparation bath. The section may be flipped over during the staining procedure. Such a flipping over may change the orientation of one section in relation to other sections.
c. Size—As described above, each structure is taken from a different section of a common histological specimen. In use, the sections may have various thicknesses. Furthermore, as more than two structures may be matched, the sections from which the structures are taken may not be sequential. The histological specimen and its structures, which are optionally fixated within a paraffin block, may have inconstant thickness along a perpendicular to the sectioning planes. Examples for such structures are spherical, conical and pyramidal structures.
d. Missing and/or additional parts—Since the histological specimen may be embedded in a fixation block, such as a paraffin block, it may have complicated topology. A certain segment that appears in one section may not appear in a sequential section and/or may appear with different shape and/or different cytological traces.
e. Deformation segments—similarly to the aforementioned missing and/or additional parts, one segment of a section may appear deformed in relation to another segment of a sequential section.
f. Overlapping segments—two or more segments which are identified as separate structures in one section may be identified as parts of a cumulative structure in another section. The overlapping of the structures may be an outcome of mishandling in the staining procedure.
g. Different topology—The spatial structure of each structure may affected by inner spaces. Due to the inner spaces, different segments of a common structure, which are taken from different sections, may have different topology.
h. Split segments—a certain structure may appear be identified as a single segment in one section and as a number of separate segments in other sections. This may be an outcome of a tissue tear or a different tissue topology, as described above.
i. Unfocused segments—unfocused images of the segments may be an outcome of a distortion that is caused to the manipulated sections, for example due to the splitting of the sections and/or any other mishandling.
j. Different magnification—as outlined above and described below, the images of the sections may be taken using a microscope camera. Such images may be taken in with different magnifications. Thus, images of different sections may depict a common structure in different magnifications. Optionally, the magnification in which the matched segments are compared is equalized before the matching. In such a manner, the matching may be performed in order to assure that the sectioned structures are approximately of the same scale.

Optionally, the aforementioned N×M probability matrix is established based on a similarity algorithm that scores each matching while taking into account some or all of the above mentioned characteristics. Optionally, during the scoring of each match, the similarity algorithm calculates similarity of one or more of the following characteristics: size, dipole moment, moment of inertia, higher moment values, and genus number.

Optionally, the similarity algorithm is based on calculating a series of coefficients such as the values of the inner contour and/or outer contour of the probed segments.

Optionally, the similarity algorithm is based on calculating a vector set that represents the center of mass of a certain segment in relation to the center of mass of other segments. This calculation may be relative to some segment inner axis, for example to the major axis of inertia.

Optionally, the aforementioned N×M probability matrix reflects the similarity between all or some of the above listed features. One element of the N×M probability matrix may reflect size differences in an absolute value. The absolute value may reflect the differences between the major axis and minor axis ratio of the segments.

In such an embodiment, the distance between segment i and segment j is calculated may be represented by the N×M probability matrix. A match between segment i and segment j is identified if the distance between i and any other segment is not smaller than the distance between segment i and segment j and does not exceed some predefined or an ad-hoc defined distance threshold value.

In some embodiment of the present invention, a verification procedure is used for estimating the credibility of the probability matrix. As described above, different sections may be taken from a common histological specimen that is fixated in a block, such as a paraffin embedded block. The coordinates of a segment of a certain structure in relation to another segment of another structure in a common section may be used for verifying the matching that is described above. For example, a vector that represents the differences between the orientations of matching segments is calculated. If the vector is below a certain threshold, the matching is verified and if the vector is above the certain threshold, the matching is tagged as unverified.

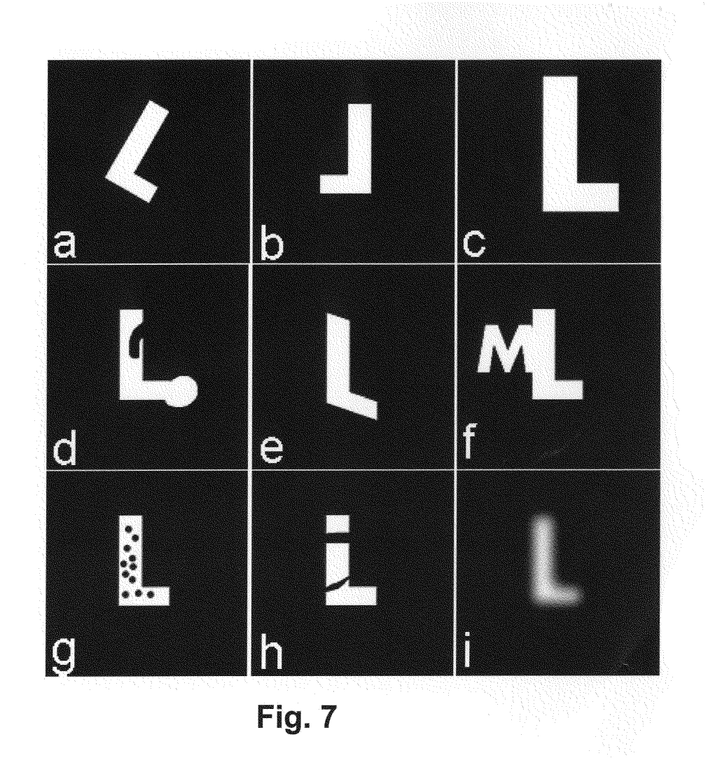

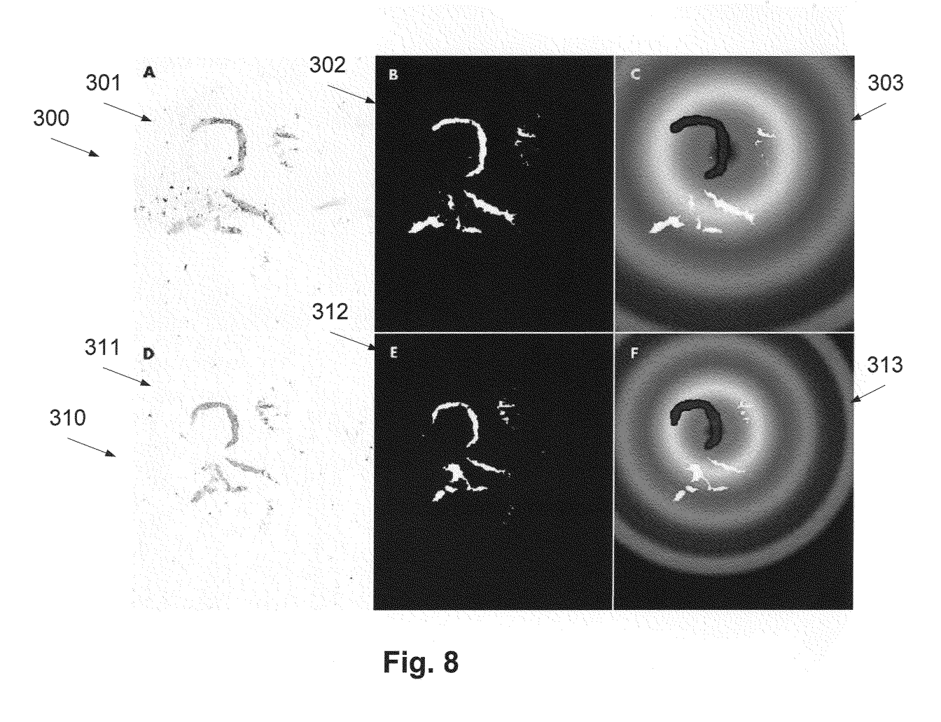

Reference is now also made to FIG. 8, which includes exemplary images of non-consecutive sections of a common histological specimen. FIG. 8 includes images of sections 300, 310 which have been processed according to a number of image processing techniques, according to some embodiments of the present invention.

FIG. 8 depicts real tissue images (RTIs) 301, 311 of non-consecutive sections with segments that may depict a section of a structure which have been eroded split, and/or combined with another structure during the trimming of the sections. Optionally, in order to reduce the computational complexity of the matching process and in order to emphasize the segments, which are depicted in the image, RTIs 301, 311 are binarized, as shown at 302 and 313. The emphasized segments in the binarized images may be used to derive a transformation between one section and another and/or an association between the structures. Optionally, such a transformation may include one or more values that define the rotation and/or the scale of one structure in relation to another, optionally the largest and/or the most consent structure. The transformation, which is based on one structure, may be used for associating between all the segments.

Reference is now made to FIG. 9 that is a schematic illustration of a system 399 for mapping structures in sections of a histological specimen, according to some embodiments of the present invention. Optionally, the system 399 includes a computing unit 400, such as a central server or a personal computer, which may be accessed via a communication network or a computer network, such as the Internet. Optionally, the computing unit 400 comprises a receiving module for receiving sections of a histological specimen from an imaging unit that is designed to capture images of sections, such as a MICROScope 405 with a digital image sensor 410. Optionally, the digital image sensor 410 is designed to be directly controlled by a computer.

Optionally, the digital image sensor 410 is connected to the receiving module via a TWAIN interface, a universal serial bus (USB) interface and/or any other interface, such as a plug-in interface. Optionally, the digital image sensor 410 is either a charge coupled device (CCD) or a complementary metal oxide semiconductor (CMOS) type. An example for such a digital image sensor 410 is 1.4 MP moving sensor that scans the image area in up to 36 increments to produce extremely high resolution final images, which the specification thereof is incorporated herein by reference.

The receiving module 401 is designed to receive images of two or more sections from the microscope 405. As depicted in FIG. 9, the system 399 further comprises a matching module 403 that is designed to associate between segments of a certain structure in different sections, as further described above. It should be noted that the different sections may be placed on a common slide and/or on different slides. Optionally, forwards association to an output module 402 that allows the displaying of the association to the user, optionally on a presentation unit, such as a screen 406.

Optionally, the association is displayed in real time, during the analysis of the specimen from which the sections have been trimmed. In such a manner, a user, such as a researcher or a pathologist, may probe a number of sections of a common histological specimen simultaneously. The association may be between a section which has been placed in front of the microscope camera in the past and the section which is currently placed in front of the microscope camera.

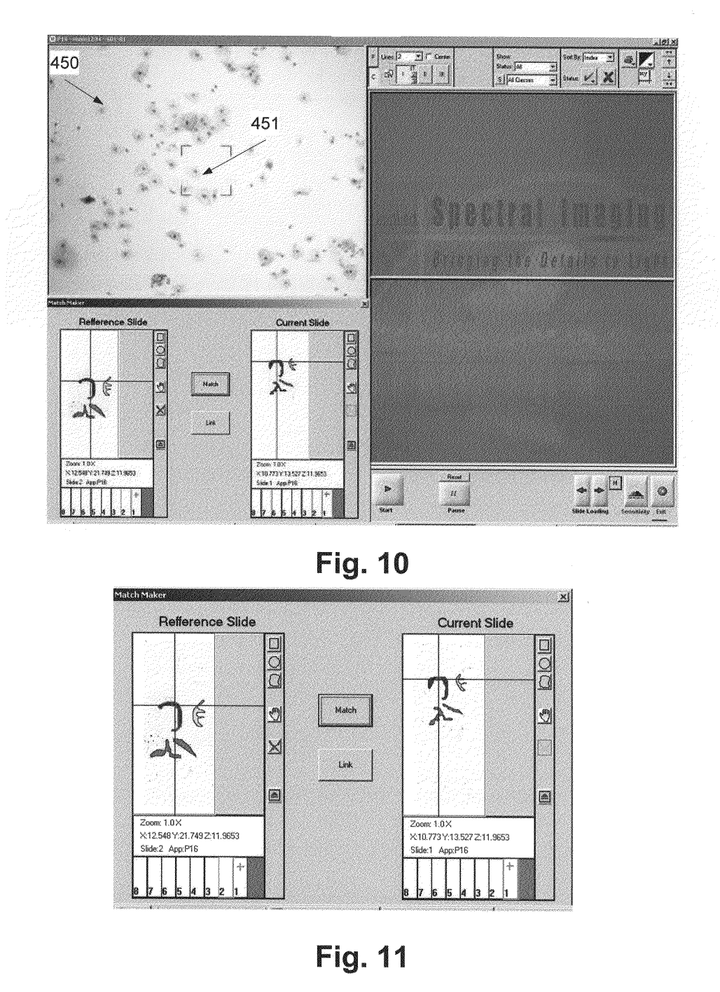

In use, the receiving module is designed to receive the images of the sections from the imaging unit 405 and/or from a repository, such a personal computer or a central server. The images are optionally forwarded via a communication network, such as the Internet. Optionally, the association is displayed on a graphical user interface (GUI) that is displayed to the user, for example as depicted in FIG. 10, which is an image of exemplary GUI 501 and in FIG. 11 which is a window 502 that is used for displaying an association between two sections, according to some embodiments of the present invention.

Optionally, the GUI 501, 502, or any other user interface, allows the user to initiate the association between different segments. Optionally, each structure that is identified on an image of the section is color-coded. In such an embodiment, the association is done by coloring segments of the same structure with similar colors, for example as shown at FIGS. 10 and 11. Optionally, each structure that is identified on an image of the section is labeled. In such an embodiment, the association is done by labeling segments of the same structure with similar labels.

As described above, the sections are trimmed from different potions of a common histological specimen; an segment of a certain structure in one section may be associated with a number of segments in another section and vice versa. In such a case, a segment in one section may have the same color as multiple structures which are related thereto in other sections.

Optionally, the GUI 501, 502 and/or any other user interface allows the user to delete and/or add an association between segments from different sections. Optionally, the association allows the mapping of matched segments. The system 399 may fully or partly map matched segments. The mapping may be applied automatically or manually, for example using the GUI. The mapping may be partial as some segments may not have respective segments in other sections. As described above, the similarity between different segments is mapped in a probability matrix. In such an embodiment, the coloring may be performed according to the probability matrix. Optionally, if the score of a certain match between two segments is above a predefined threshold, the matched segments are colored with the same color.

In some embodiment of the present invention, the orientation of one image is adjusted according to the association between the structures. Optionally, the orientation is determined according to the one or more matched segments with the highest scores. As further described above, the orientation of one section is transformed according to a transformation between segments of a common structure. Optionally, the user uses the GUI 501, 502, for associating between different segments of a common structure.

In some embodiments of the present invention, the GUI 501, 502 may be used for facilitating the identification of segments associated with a selected area. For example, while the user maneuvers a cursor, such as a crosshair cursor, to indicate a certain area in one segment of an image of one section, another cursor, such as a crosshair cursor, may be maneuvered to indicate on one or more matching areas in one or more respective segments of another image of a different section.

In some embodiments of the present invention, the matching process is performed during the probing of certain sections. In such an embodiment, an image of a first image of a first section is captured and optionally stored in the memory of the system 399. Then, the user may tag areas on the first image, optionally using the curser. Then, the user uses the imaging unit 405, which is optionally a microscope, for probing a second image of a second section. The matching module 403 may now associate between the tagged areas in the first image and respective areas in the second image and display an indication to the association, for example by highlighting the respective tagged areas in the second image. In such a manner, the user may tag areas of interest in the first section and receive an indication about respective areas that appear in the second section that is optionally stained using a different staining dye.

Optionally, segments of the image of the first image are matched with respective segments of the image section and/or with an image of another section that is captured in a higher magnification. Optionally, the image of the first section is captured in a relatively low magnification, for example as depicted in numeral 450 of FIG. 10. Such images allow the matching of selected segments, such as numeral 451 of FIG. 10, with segments of an image of the second section that is captured with any higher magnification. Optionally, the abovementioned magnification of the first section is between 1× and 10× and allows a match-up optimization. Both sections are optionally presented to the user. Optionally, the user may select a number of areas. In such an embodiment, the respective area may be indicated differently, for example by a different color and/or label. The matching module 403 may perform the aforementioned association and indication display during the probing process, allowing the user to maneuver the section, for example by moving the slide that carries it, without losing the indication.

It is expected that during the life of a patent maturing from this application many relevant systems and methods will be developed and the scope of the terms image sensor, microscope, operating system, and imaging are intended to include all such new technologies a priori.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, 25 and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for presenting at least one structure of a histological specimen, the method comprising:
providing a plurality of images of a plurality of sections of a single histological specimen having a plurality of structures;
segmenting a plurality of segments of said plurality of structures in each said image;
associating among respective said segments of a common structure of said plurality of structures; and
presenting said association in relation to at least some of said plurality of images.

2. The method of claim 1, further comprising matching pixels of a segment of said plurality of segments with respective pixels of an associated segment of said plurality of segments.

3. The method of claim 1, wherein each said section is stained using at least one of a different staining procedure and a different staining agent.

4. The method of claim 1, wherein at least some of said associated segments are depicted in non-consecutive sections of said plurality of sections.

5. The method of claim 1, wherein said displaying further comprising aligning at least one of said plurality of images according to said association.

6. The method of claim 1, wherein said displaying further comprising reorienting at least one of said plurality of images according to said association.

7. The method of claim 1, wherein said associating comprises identifying a transformation between at least two of said plurality of segments.

8. The method of claim 1, wherein said associating comprises acquiring positional information of at least two of said associated segments, said presenting comprises adjusting said at least two of said associated segments according to said positional information.

9. The method of claim 1, further comprising verifying said associating by matching positional information of at least two of said associated segments.

10. The method of claim 1, wherein each said section is positioned on a single specimen slide.

11. The method of claim 1, wherein said associating comprises coloring said associated segments in a single color.

12. The method of claim 1, wherein said associating comprises labeling said associated segments with a single label.

13. The method of claim 1, wherein said associating comprises scoring the similarity between at least one pair of said plurality of segments and associating said segments according to said scoring.

14. The method of claim 13, wherein said associating comprises generating a probability matrix according to said scoring and associating said plurality of segments according to said probability matrix.

15. A system for presenting a histological specimen, said system comprising:
a receiving module configured for receiving a plurality of images of a plurality of sections of a single histological specimen having a plurality of structures;
a matching module configured for mapping segments of each said structure in each said section and associating among respective said segments of a common structure of said plurality of structures; and
an output module configured for allowing the presenting of an indication of said association in relation to at least one of said plurality of images.

16. The system of claim 15, further comprising a user interface configured for allowing a user to select at least one of said plurality of segments, said matching module being configured for performing said mapping according to said selection, said associating comprising associating an area respective to said selected area.

17. The system of claim 15, wherein said matching module is configured for aligning said plurality of images according to said associating, said indication comprising said aligned images, said presentation unit being configured for displaying said aligned images to a user.

18. An apparatus for allowing the presentation of a single histological specimen, said apparatus comprising:
a receiving module configured for receiving a plurality of images each of a different section of a single histological specimen;
a user interface for allowing a user to select a first area in a first location in one of said plurality of images;
a matching module configured for identifying a second area in a second location in another of said plurality of images, said second location being respective to said first location; and
an output module configured for allowing the presenting of an association between said first and second areas according to said identification.

19. The apparatus of claim 18, wherein said matching module is configured for identifying said second area by segmenting a plurality of segments of a plurality of structures of said single histological specimen in each said image, and associating among segments of each said structure.

20. The apparatus of claim 18, wherein said receiving module is configured to receive said plurality of images from a microscope camera.

21. The apparatus of claim 18, wherein said output module is configured for allowing said presenting automatically in response to said user selection of said first area.
